(19) United States
(12) Patent Application Publication
(10) Pub. No.: US 2017/0230916 A1
(43) Pub. Date: Aug. 10, 2017

(54) WIRELESS NETWORK POWER DISTRIBUTION AND DATA AGGREGATION SYSTEM TOPOLOGY

(71) Applicant: Analog Devices, Inc., Norwood, MA (US)

(72) Inventors: YOSEF STEIN, Sharon, MA (US); Wei AN, Newton, MA (US); Roman TROGAN, Needham, MA (US)

(73) Assignee: Analog Devices, Inc., Norwood, MA (US)

(21) Appl. No.: 15/515,482

(22) PCT Filed: Oct. 1, 2015
(86) PCT No.: PCT/US15/53598

§ 371 Date: Mar. 29, 2017

Related U.S. Application Data
(60) Provisional application No. 62/058,219, filed on Oct. 1, 2014.
(60) Provisional application No. 62/108,412, filed on Jan. 27, 2015.

(51) Int. Cl. H04W 52/34; H04W 4/00; H04B 1/69; H02J 50/20

(52) U.S. Cl. CPC H04W 52/34; H02J 50/20; H04W 4/006; H04B 1/69

(57) ABSTRACT

A wireless network power distribution and data aggregation system, along with associated applications, is disclosed. An exemplary system for wirelessly transmitting power to radio frequency (RF) energy harvesting sensor nodes of a wireless network system includes a pyramid-structured antenna array for wirelessly powering RF energy harvesting sensor nodes within a defined coverage area of the wireless network system. The pyramid-structured antenna array generates a radiation pattern from an orthogonal spread-spectrum signal that minimizes destructive interference between adjacent antennas of the antenna array. Each antenna of the antenna array can wirelessly transmit power to a respective sector of the defined coverage are.

### CROSS-REFERENCE TO RELATED PATENT APPLICATIONS

This application claims priority to (1) U.S. Provisional Patent Application Ser. No. 62/058,219, filed Oct. 1, 2014, and entitled Wireless Network Power Distribution and Data Aggregation System Topology and (2) U.S. Provisional Patent Application Ser. No. 62/108,412, filed Jan. 27, 2015, and entitled Wireless Network Power Distribution and Data Aggregation System and Associated Applications, both of which are hereby incorporated by reference in their entirety.

### TECHNICAL FIELD

The present disclosure relates generally to wireless network environments, and more particularly, to wireless power distribution and wireless data aggregation in wireless network environments.

### BACKGROUND

Radio frequency (RF) system and wireless sensor network (WSN) are two technologies integrated to provide a wide variety of applications, particularly where merging the physical world with the digital world (also referred to as the virtual world). For example, where energy-constraints confine network performance of a wireless sensor network, RF energy harvesting schemes can be implemented to provide power (energy) to various nodes of the wireless sensor network, while further extending sensing capabilities of the wireless sensor network. In such scenarios, wireless power is efficiently and optimally transmitted to the various nodes. Although existing wireless power transmission and data aggregation systems and methods in wireless network environments have been generally adequate for their intended purposes, they have not been entirely satisfactory in all respects.

### BRIEF DESCRIPTION OF DRAWINGS

The present disclosure is best understood from the following detailed description when read with the accompanying figures. It is emphasized that, in accordance with the standard practice in the industry, various features are not drawn to scale and are used for illustration purposes only. In fact, the dimension of the various features may be arbitrarily increased or reduced for clarity of discussion.

FIG. 1 is a schematic block diagram of an exemplary communications system for optimizing wireless power transmission in a network environment according to various aspects of the present disclosure.

FIG. 2 is a schematic diagram of an exemplary wireless charging network system topology for a defined coverage area of the communications system of FIG. 1 according to various aspects of the present disclosure.

FIG. 3 is a schematic block diagram of an exemplary full function device node for aggregating data and wirelessly transmitting power, which can be implemented in the communications system of FIG. 1, according to various aspects of the present disclosure.

FIG. 4 is a schematic block diagram of an exemplary reduced function device node for wirelessly transmitting power, which can be implemented in the communications system of FIG. 1, according to various aspects of the present disclosure.

FIG. 5 is a schematic block diagram is a schematic diagram of another exemplary communications system for optimizing wireless power transmission in a network environment according to various aspects of the present disclosure.

FIG. 6 is another schematic block diagram of the communications system for optimizing wireless power transmission of FIG. 5 according to various aspects of the present disclosure.

FIG. 7 is a schematic block diagram of an exemplary sensor node for a network environment according to various aspects of the present disclosure.

FIG. 8 is a schematic block diagram of an exemplary gateway node for wirelessly transmitting power in a network environment according to various aspects of the present disclosure.

FIG. 9 is schematic block diagram of the gateway node of FIG. 8 for wirelessly transmitting power in a network environment according to various aspects of the present disclosure.

FIG. 10 is a schematic diagram of an exemplary wireless avionics intra-communication (WAIC) network environment according to various aspects of the present disclosure.

### OVERVIEW OF EXAMPLE EMBODIMENTS

The present disclosure provides various wireless network power distribution and data aggregation systems, along with associated applications. An exemplary system for wirelessly transmitting power to radio frequency (RF) energy harvesting sensor nodes of a wireless network system includes a pyramid-structured antenna array for wirelessly powering RF energy harvesting sensor nodes within a defined coverage area of the wireless network system. The pyramid-structured antenna array generates a radiation pattern from an orthogonal spread-spectrum signal that minimizes destructive interference between adjacent antennas of the antenna array. Each antenna of the antenna array can wirelessly transmit power to a respective sector of the defined coverage area. Each antenna of the antenna array can generate a respective radiation pattern from RF signals modulated with different orthogonal spread-spectrum sequences. The pyramid-structured antenna array can achieve a uniform radiation pattern exhibiting greater than zero gain for each sector of the defined coverage area.

The system is further configured to wirelessly transmit power to the RF energy harvesting sensor nodes without using an uplink communication link from the RF energy harvesting sensor nodes to gather three-dimensional location information associated with the RF energy harvesting sensor nodes. In some implementations, the pyramid-structured antenna array includes a pyramid-shaped ground board formed from pyramid-shaped ground planes, and a patch antenna mounted to each pyramid-shaped ground plane. In some implementations, the antenna array includes four antennas, and the sector of each antenna has an angle of coverage of about 90 degrees. In some implementations, the system further includes a phase modulator for each antenna of the antenna array, wherein each phase modulator modulates an RF signal fed to a respective antenna using a different orthogonal spread-spectrum sequence. In some implementations, the antenna array is further configured to vary the radiation pattern to selectively power on/off or selectively charge at least one RF energy harvesting sensor node within the defined coverage area. In some implementations, wherein the antenna array is further configured to selectively switch each antenna in/out of the antenna array to vary the radiation pattern to achieve a defined quality of service.

An exemplary wireless charging network system topology includes a radio frequency energy distributor and data aggregator (REDDA) system configured to aggregate data from sensor nodes within a defined coverage area. The REDDA system is also configured to wirelessly transmit power to sensor nodes within an assigned portion of the defined coverage area. The wireless charging network system topology further includes a plurality of radio frequency energy distributor (RED) systems assigned respective portions of the defined coverage area. Each RED system is configured to wirelessly transmit power to sensor nodes within the respective portion of the defined coverage area. The assigned portions of the defined coverage area can overlap to facilitate wireless charging of the sensor nodes from more than one energy source and/or more than one angle. In some implementations, the REDDA system and each RED system are configured to selectively power on/off or selectively charge at least one sensor node within the respective portion of defined coverage area. In some implementations, a ratio of the REDDA system to RED systems in the defined coverage area is 1:5 or 1:10.

In some implementations, the REDDA system and/or each RED system includes an antenna array for wirelessly transmitting power to the assigned portion of the defined coverage area, wherein each antenna of the antenna array is configured to wirelessly transmit power to a sector of the assigned portion. The REDDA system and/or each RED system can selectively switch each antenna in/out of the antenna array to achieve various radiation patterns for wirelessly transmitting power. In some implementations, the sector of each antenna has an angle of coverage of at least 60 degrees. The REDDA system and/or each RED system may be configured for omni-directional coverage. In some implementations, the REDDA system and/or each RED system are configured to set various radiation patterns for wirelessly transmitting power to the sensor nodes in a manner that achieves a defined quality of service.

In some implementations, the REDDA system may be configured to aggregate data from the sensor nodes and wirelessly transmit power to the sensor nodes on different radio bands. The REDDA system may further include an omni-directional antenna for aggregating data and an Internet of Things (IoT) interface connected to an IoT network. In some implementations, a sensitivity of a transceiver for aggregating the data is greater than a sensitivity of a transceiver for wirelessly transmitting power.

In aviation application, an exemplary method for communicating data in a wireless avionics communication network that avoids interference with periodic signals transmitted in an aviation environment includes tracking a frequency of periodic signal as it sweeps a defined frequency band, and scheduling a frequency band for data communication within the defined frequency band based on the tracked frequency of the periodic signal. Scheduling the frequency band for data communication can include, but is not limited to, assigning a time for using the frequency band for data communication and/or assigning a modulation scheme associated with the frequency band for data communication. In some implementations, the method further includes assigning sensor nodes associated with the wireless avionics communication network a frequency band for data communication within the defined frequency band based on the frequency of the tracked periodic signal. In some implementations, the method further includes broadcasting the frequency band, an assigned time for using the frequency band for data communication, and a modulation scheme associated with the frequency band for data communication to sensor nodes associated with the wireless avionics communication network. The method may further include transmitting and receiving data during the scheduled frequency band for data communication within the defined frequency band.

In some implementations, the method further includes alternating tracking of the frequency of the periodic signal and aggregating data between at least two transceivers based on the frequency of the periodic signal, and assigning each scheduled frequency band for data communication a time and a modulation scheme based on the frequency of the periodic signal. In some implementations, the periodic signal is a radio altimeter signal that sweeps a radio altimeter frequency band, where a frequency band for data communication is scheduled based on a tracked frequency of the radio altimeter signal. In some implementations, the radio altimeter signal is tracked from a ground level to a pre-defined height above ground level, where any frequency band may be scheduled for data communication within the radio altimeter frequency band above the pre-defined height above ground level.

An exemplary wireless avionics communication network for communicating data in a manner that avoids interference with periodic signals transmitted in an aviation environment includes a gateway node configured to aggregate data from sensor nodes associated with the wireless avionics communication network. The gateway node is configured to track a frequency of a periodic signal as it sweeps a defined frequency band, and schedule a frequency band for data communication within the defined frequency band based on the tracked frequency of the periodic signal. Scheduling the frequency band for data communication includes assigning a time for using the frequency band for data communication and/or a modulation scheme associated with the frequency band for data communication. Scheduling the frequency band for data communication can include scheduling multiple frequency bands for data communication, wherein each frequency band is assigned a different modulation scheme, and further wherein the modulation scheme is one of direct-sequence spread spectrum (DSSS), orthogonal frequency division multiplexing (OFDM), and frequency shift keying (FSK).

In some implementations, the gateway node includes at least two transceivers configured to, based on the frequency of the periodic signal, alternate between tracking of the frequency of the periodic signal and aggregating data from the sensor nodes. Each of the at least two transceivers is configured to support simultaneously a mix of modulation schemes assigned to frequency bands for data communication, wherein the modulation schemes are one of direct-sequence spread spectrum (DSSS), orthogonal frequency division multiplexing (OFDM), frequency shift keying (FSK), and a combination thereof. In some implementations, the gateway node uses a media access control (MAC) layer to define a frequency band for data communication for each sensor data link, a time assigned for using the defined frequency band for data communication, and a modulation scheme assigned for the defined frequency band based on the frequency of the periodic signal.

In some implementations, the at least two transceivers include a first transceiver configured to track the frequency of the periodic signal in a first frequency band of the defined frequency band, and a second transceiver configured to track the frequency of the periodic signal in a second frequency band of the defined frequency band. The first frequency band may be a lowest defined frequency band of the defined frequency band, and the second frequency band may be a highest defined frequency band of the defined frequency band. In some implementations, the first transceiver is further configured to receive data from the sensor nodes on the first frequency band, and the second transceiver is further configured to receive data from the sensor nodes on the second frequency band.

In some implementations, the periodic signal is a radio altimeter signal that sweeps a radio altimeter frequency band, where a frequency band for data communication is scheduled based on a tracked frequency of the radio altimeter signal. During takeoff or landing of an aircraft, one of the at least two transceivers tracks the radio altimeter signal while a remaining of the at least two transceivers aggregates data from the sensor nodes. The radio altimeter signal may be tracked from a ground level to a pre-defined height above ground level, where the gateway node can schedule any frequency band for data communication within the radio altimeter frequency band above the pre-defined height above ground level.

### DETAILED DESCRIPTION OF EXAMPLE EMBODIMENTS

Wireless sensor networks (WSN) used for monitoring physical and environmental conditions have become a driving force in fast growing markets, such as machine monitoring and building automation. Industrial applications will comprise a major portion of the massive growth of internet connected nodes over the next six years (some reports indicate expect the unit volume to scale from 9 billion units in 2014 to over 100 billion units by 2020). In many applications, a sensor node's battery life, along with associated operating expenses and maintenance costs associated with battery replacement, poses a significant challenge for adopting WSN systems. The advent of battery-less or battery-assisted WSN sensor nodes provides a competitive advantage in many applications facing challenging environmental conditions across a variety of end equipment markets. Energy harvesting technology has been implemented by WSN systems to enable battery-less or battery-assisted WSN sensor nodes for quite some time. However, since energy harvesting schemes typically implement ambient energy sources (such as photovoltaic energy sources, thermal energy sources, and/or vibration energy sources) that exhibit intermittent availability, conventional energy harvesting schemes lack control necessary to predictably and consistently power sensor nodes. Controllable distribution of energy to the battery-less and battery-assisted sensor node has the potential to enable a wireless model to take hold as the most optimal platform for Internet of Things (IoT) connectivity irrespective of the application's environmental or operating conditions.

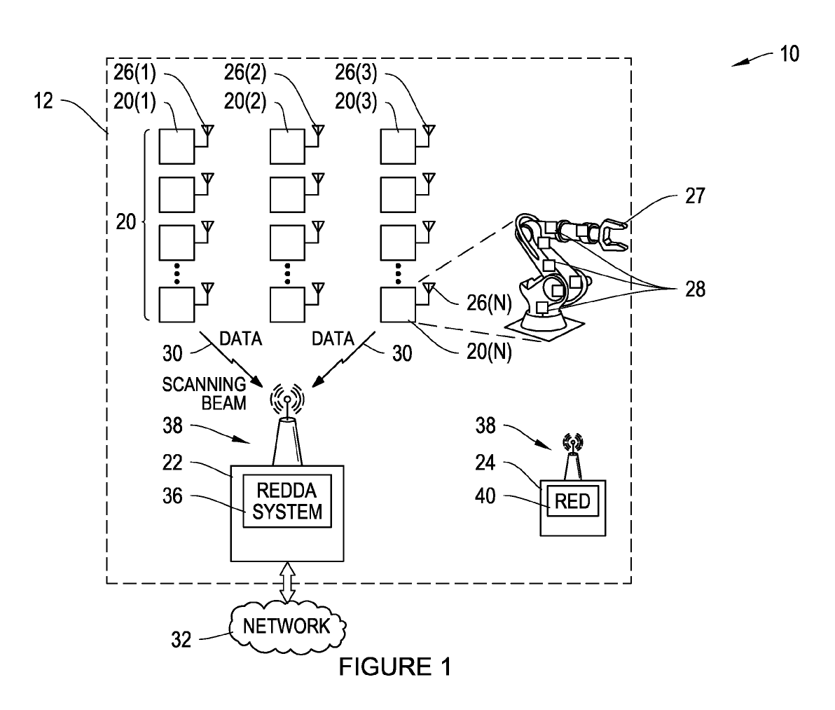

The present disclosure provides an RF Energy Distribution and Data Aggregation (REDDA) system for RF wirelessly charging battery-less or battery-assisted WSN sensor nodes (also referred to as RF energy harvesting sensor nodes). FIG. 1 is a schematic block diagram of an exemplary communications system 10 for optimizing wireless charging (also referred to as wireless power transmission) in a network environment according to various aspects of the present disclosure. Communications system 10, which implements the REDDA system described herein, can be implemented in process control and automation applications, for example, a process control and automation system for performing targeted machine monitoring and/or state-of-health applications. FIG. 1 has been simplified for the sake of clarity to better understand the inventive concepts of the present disclosure. Additional features can be added in communications system 10, and some of the features described herein can be replaced or eliminated in other embodiments of communications system 10.

In FIG. 1, communications system 10 includes a wireless network system 12, such as a wireless sensor network. Wireless network system 12 includes sensor nodes 20 that communicate wirelessly with at least one full function device node 22 (also referred to as a gateway node) and at least one reduced function device node 24. Each sensor node 20 can collect data from its surrounding environment (e.g., wireless network system 12) and communicate the collected data via data signals to full function device node 22 for further processing. Any number of sensor nodes 20, full function device nodes 22, and reduced function device nodes 24 can be provided within wireless network system 12. In various embodiments, wireless network system 12 can include hundreds or even thousands of sensor nodes 20, where at least one full function device node 22 is used to communicate with the sensor nodes 20. For purposes of the following discussion, and in various embodiments, wireless network system 12 represents a radio frequency identification (RFID) system, where sensor nodes 20 include RFID tags that store data, and full function device node 22 includes an RFID reader that communicates wirelessly with the RFID tags to collect data from and charge (power) the RFID tags. In various embodiments, sensor nodes 20 can be distributed throughout a location, for example, within and/or around a building, such as a warehouse, where at least one full function device node 22 can track information associated with the building or objects, people, animals, and/or entities (collectively referred to as things) associated with the building. In various embodiments, sensor nodes 20, full function device node 22, and/or reduced function device node 24 can wirelessly communicate using any appropriate communication standard, including Wi-Fi (for example, IEEE 802.11), Bluetooth, an IEEE 802.15.x communication standard (such as SmartGrid IEEE 802.15.4g and/or WBAN IEEE 802.15.6g), other appropriate communication standard, and/or variations thereof.

Sensor nodes 20 can include sensor nodes 20(1), 20(2), 20(3), . . . , 20(N) having associated antennas 26(1), 26(2), 26(3), . . . , 26(N), where N is a total number of sensor nodes 20 in wireless network system 12. Each sensor node 20 can include a sensing unit, a processor, an RF transceiver, and an energy source (also referred to as a power source). Depending on applications of wireless network system 12, sensor nodes 20 may have identical or varying sensing, processing, transmitting, receiving, and/or powering capabilities. The sensing unit includes one or more sensors, such as optical, magnetic, mechanical, thermal, biological, chemical, visual, infrared, and/or other type of sensors for monitoring various parameters within or around wireless network system 12. In various embodiments, each sensor node 20 can represent a robot. For example, sensor node 20(N) includes a robot 27 having various sensors 28 (seven sensors in the depicted embodiment), where full function device node 22 can wirelessly collect data from each sensor 28. The power source of sensor nodes 20 can be an internal power source, such as a battery internal to sensor nodes 20 (for example, where sensor nodes 20 include an active RFID tag), an external power source, such as RF energy received from full function device node 22 and/or reduced function node 24 (for example, where sensor nodes 20 include a passive RFID tag), or a combination thereof (for example, where sensor nodes 20 include a semi-passive RFID tag). In various embodiments, as described further below, sensor nodes 20 wirelessly derive at least a portion of power from full function device node 22 and/or reduced function device node 24, particularly from energy, such as RF energy, from full function device node 22 and/or reduced function device node 24. In various embodiments, each sensor node 20 includes an energy harvesting mechanism for deriving, capturing, and storing energy from external sources (for example, RF energy from full function device node 22 and/or reduced function device node 24). In some embodiments, sensor nodes 20 operate solely off RF energy harvested from full function device node 22 and/or reduced function device node 24. Sensor nodes 20 can thus be referred to as RF energy harvesting sensor nodes.

As noted, full function device node 22 can aggregate data collected by sensor nodes 20, and can wirelessly charge sensor nodes 20, for example, by wirelessly transmitting power to sensor nodes 20; and reduced function device node 24 can wirelessly charge sensor nodes 20, for example, by wirelessly transmitting power to sensor nodes 20. In the depicted embodiment, full function device node 22 includes a radio frequency energy distributor and data aggregator (REDDA) system 36 that aggregates data from sensor nodes 20 and wirelessly transmits power to sensor nodes 20 using a respective selectively formed signal 38; and reduced function device node 24 includes a radio frequency energy distributor (RED) system 40 that wirelessly transmits power to sensor nodes 20 using respective selectively formed signal 38, similar to REDDA system 36, such that sensor nodes 20 can operate using energy harvested from selectively formed signal 38. In various embodiments, full function device node 22 receives data signals 30 from sensor nodes 20 (including from each sensor 28 of sensor nodes 20), which include information about the surrounding environment of each sensor node 20. Full function device node 22 can communicate the collected data to network elements of wireless network system 12 or to network elements over a network 32. In various embodiments, full function device node 22 communicates with a host computer system and/or a host database within wireless network system 12 or with host computer system and/or host database over network 32, which can communicate with an application for processing information collected from sensor nodes 20. Alternatively, in various embodiments, full function device node 22 can communicate directly with an application over network 32. As used herein, the term “network element” can encompass computers, network appliances, servers, routers, switches, bridges, load balancers, firewalls, processors, modules, or any other suitable device, component, element, or object operable to exchange information in a network environment, such as communication system 10. Moreover, the network elements may include any suitable hardware, software, components, modules, interfaces, or objects that facilitate the operations thereof. This may be inclusive of appropriate algorithms and communication protocols that allow for the effective exchange of data or information.

In various embodiments, communication system 10 represents an Internet of Things (IoT) system, where things (for example, objects, people, animals, and/or entities) and sensors within or attached to these things are connected to the Internet. The things can be connected to the Internet via wireless and/or wired connections. For example, in various embodiments, network 32 is the Internet, and full function device node 22 includes an IoT interface that connects full function device node 22 to network 32, such that information collected by sensor nodes 20 can be communicated to network elements and/or applications over the Internet. In various embodiments, full function device node 22 wirelessly communicates with network elements and/or applications over the Internet. In such embodiments, wireless network system 12 can serve as a backhaul network, and in some embodiments, where wireless network system 12 includes a host computer system connected to full function device node 22, the host computer system can serve as a backhaul computer. Furthermore, communication system 10 may be configured over a physical infrastructure that includes one or more networks and, further, can be configured in any form including, but not limited to, local area networks (LANs), wireless local area networks (WLANs), virtual local area networks (VLANs), metropolitan area networks (MANs), wide area networks (WANs), virtual private networks (VPNs), Internet, Intranet, Extranet, any other appropriate architecture or system, or any combination thereof that facilitates communications as described herein. In some embodiments, communication links may represent any electronic link supporting a LAN environment such as, for example, cable, Ethernet, wireless technologies (for example, IEEE 802.11x), ATM, fiber optics, or any suitable combination thereof. In other embodiments, communication links may represent a remote connection through any appropriate medium (such as digital subscriber lines, telephone lines, T1 lines, T3 lines, wireless, satellite, fiber optics, cable, Ethernet, etc. or any combination thereof) and/or through any additional networks.

In various embodiments, REDDA system 36 aggregates data from sensor nodes 20 and wirelessly transmits power to sensor nodes 20 on different radio bands, such as different ISM radio bands. For example, REDDA system 36 receives data signals 30 from sensor nodes 20 on a narrowband radio, and wirelessly transmits power via selectively formed signal 38 to sensor nodes 20 on a wideband radio. Using different radio bands for aggregating and transmitting can prevent (or minimize) collision of data signals 30 and/or selectively formed 38 and/or minimize data retransmission. In various embodiments, REDDA system 36 can include a wideband aggregator receiver, and sensor node 20 can include a sensor narrowband radio, where REDDA system 36 can aggregate data from the sensor narrowband radio using the wideband aggregator receiver in a manner that avoids data collision and minimizes data retransmission. In various embodiments, REDDA system 36 can scan in a frequency ISM band ranging from about 902 MHz to about 928 MHz (an unlicensed frequency ISM band for North America). Within this frequency band, REDDA system 36 can allocate about 10 MHz for wirelessly transmitting power, and about 16 MHz for aggregating data. In various embodiments, sensor nodes 20 can be configured with narrowband modulators (for example, IEEE 802.15.4g narrowband modulators) using a frequency band having a bandwidth that ranges from about 50 KHz to about 200 KHz for transmitting data. In various embodiments, REDDA system 36 aggregates data and RED system 40 wirelessly transmits power on different radio bands.

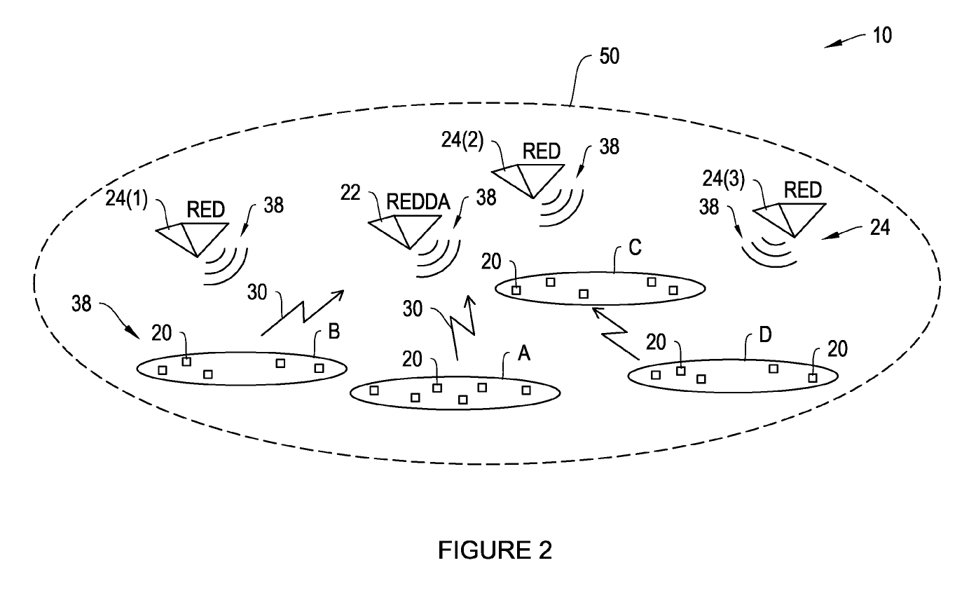

FIG. 2 is a schematic diagram of an exemplary wireless charging network system topology for a defined coverage area of communications system 10 according to various aspects of the present disclosure. In FIG. 2, wireless charging network system topology achieves wireless data aggregation and power transmission (distribution) using a mix of full function device nodes (such as full function device node 22) and reduced function device nodes (such as reduced function device node 24) for a defined coverage area 50 of communications system 10. Though a single defined coverage area 50 is depicted in FIG. 2, the present disclosure contemplates that communication system 10 can have various defined coverage areas, where each defined coverage area has an associated mix of full function device nodes 22 and/or reduced function device nodes 24. In various embodiments, defined coverage area 50 is associated with a location, for example, within and/or around a building, such as a warehouse. In some embodiments, full function device nodes 22 and/or reduced function device nodes 24 can be mounted to a wall and/or ceiling associated with the location. As described further below, implementing the mixed function device node topology to aggregate data from and wirelessly transmit data to sensor nodes 20 can significantly reduce wireless sensor network costs, while optimizing wireless power transmission. FIG. 2 has been simplified for the sake of clarity to better understand the inventive concepts of the present disclosure. Additional features can be added in wireless charging network system topology of communications system 10, and some of the features described herein can be replaced or eliminated in other embodiments of wireless charging network system topology of communications system 10.

In the depicted embodiment, a single full function device node 22 and multiple reduced function device nodes 24 (such as a reduced function device node 24(1), a reduced function device node 24(2), and a reduced function device node 24(3)) provide wireless sensor networking functions to defined coverage area 50. For example, full function device node 22 aggregates data from sensor nodes 20 within defined coverage area 50, and both full function device node 22 and reduced function device nodes 24 wirelessly transmit power to sensor nodes 20 within defined coverage area 50. As noted above, full function device node 22 includes REDDA system 36 for wirelessly aggregating data and wirelessly transmitting power, while each reduced function node 24 includes RED system 40 for wirelessly transmitting power. Each device node wirelessly transmits power to sensor nodes 20 within a respective, assigned portion of defined coverage area 50. For example, in the depicted embodiment, defined coverage area 50 includes a portion A, a portion B, a portion C, and a portion D, where full function device node 22 wirelessly transmits power to sensor nodes 20 within portion A, reduced function device node 24(1) wirelessly transmits power to sensor nodes 20 within portion B, reduced function device node 24(2) wirelessly transmits power to sensor nodes 20 within portion C, and reduced function device node 24(3) wirelessly transmits power to sensor nodes 20 within portion D. In various embodiments, respective, assigned portions of defined coverage area 50 can overlap, such that more than one function device node can wirelessly transmit power to sensor nodes 20 within an area. For example, portion A and portion B may overlap, such that both full function device node 22 and reduced function device node 24(1) can wirelessly transmit power to sensor nodes within the overlapping area of portion A and portion B. In various embodiments, by overlapping the assigned portions of defined coverage area 50, sensor nodes 20 can be charged by more than one energy source (such as by more than one function device node). Such configuration can achieve charging of sensor nodes 20 from different angles and/or different lines of sight, which can optimize wireless charging of sensor nodes 20.

The mixed topology network described herein is achieved by recognizing that wireless sensor network functionalities are not symmetric when considering sensitivities to aggregating data and wirelessly transmitting power, such as a transceiver's varying sensitivity to aggregating data and wirelessly transmitting power. For example, in various embodiments, a transceiver's sensitivity to data aggregation may range from about −90 dBm to −107 dBm, while a transceiver's sensitivity to wirelessly transmitting power may range from about 0 dBm to −20 dBm. Based on this vast difference in transceiver sensitivity, the present disclosure recognizes that not every function device node must be a full function device node needing both transmit and receive capabilities, such as full function device node 22. Instead, a single full function device (for example, having both data aggregation and wireless power transmission capabilities) can be combined with at least one reduced function device (for example, having wireless power transmission capabilities only) to provide optimal wireless sensor networking functionalities for defined coverage area 50. Essentially, data aggregation capabilities can be removed from all but one node associated with the defined coverage area, which can significantly simplify wireless sensor network architecture, and thereby significantly reduce overall wireless sensor network costs. In various embodiments, defined coverage area 50 can include any ratio of full function device nodes 22 (including REDDA system 36) to reduced function device nodes 24 (including RED system 40), such as a ratio of 1:5 to a ratio of 1:10.

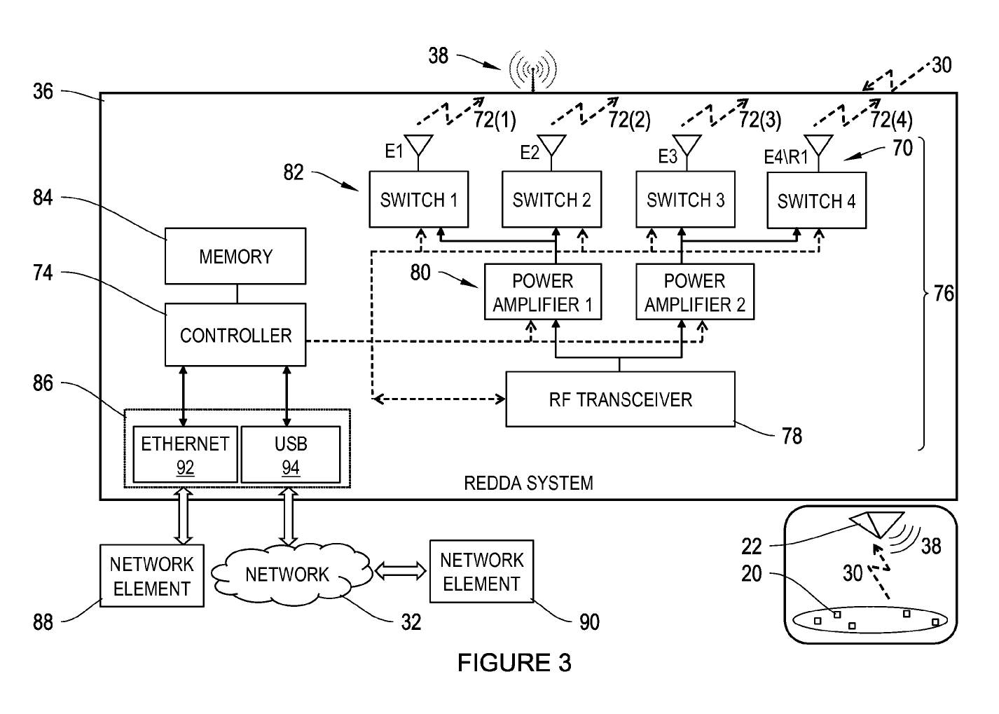

FIG. 3 is a schematic block diagram of an exemplary REDDA system 36, which can be implemented in full function device node 22, according to various aspects of the present disclosure. REDDA system 36 can be implemented using various distributed integrated circuits and/or devices interconnected with each other, such that components of REDDA system 36 are integrated to provide the functions described herein. FIG. 3 has been simplified for the sake of clarity to better understand the inventive concepts of the present disclosure. Additional features can be added in REDDA system 36, and some of the features described can be replaced or eliminated in other embodiments of REDDA system 36.

As noted, REDDA system 36 aggregates data from sensor nodes 20 (via data signals 30) and produces selectively formed signal 38 for wirelessly charging sensor nodes 20. For example, REDDA system 36 includes an antenna array 70 having multiple antennas (elements) E1, E2, E3, and E4 that transmit associated RF signals 72(1), 72(2), 72(3), and 72(4) (collectively referred to as RF signals 72) to achieve various radiation patterns for selectively formed signal 38. REDDA system 36 vary selectively formed signal 38 to achieve different radiation patterns for optimizing wireless power transmission. In FIG. 3, REDDA system 36 includes an antenna that both receives and transmits RF signals, such as antenna E4/R1 that both receives data signals 30 and transmits associated RF signal 72(4). Alternatively, in some embodiments, REDDA system 36 can include a separate antenna for receiving data signals 30. In various implementations, REDDA system 36 includes a single antenna for receiving data signals 30 to collect information from sensor nodes 20. Alternatively, REDDA system 36 can include more than one antenna for receiving data signals 30. In various embodiments, REDDA system 36 includes an omni-directional antenna.

Antenna array 70 can include a linear array, a circular array, a planar array, a conformal array, or other type of array. In various embodiments, each antenna E1, E2, E3, and E4 is associated with a defined sector of the portion of defined coverage area 50, where each antenna E1, E2, E3, and E4 wirelessly transmits power to sensor nodes 20 within its respective defined sector. For example, referring to FIG. 2, where full function device node 22 includes REDDA system 36, antennas E1, E2, E3, and E4 each have an associated sector of portion A of defined coverage area 50. In various embodiments, antennas E1, E2, E3, and E4 can have adjacent or overlapping sectors depending on design considerations. Each antenna E1, E2, E3, and E4 has an angle of coverage of at least 60 degrees. In various embodiments, each antenna E1, E2, E3, and E4 has an angle of coverage of 90 degrees, thereby providing a full 360 degrees coverage. In various embodiments, as depicted in FIG. 2 and FIG. 3, full function node 22 may be a pyramid-structured device having four faces, where each face is associated with one of antennas E1, E2, E3, E4, such that each face powers (wirelessly charges) sensor nodes 20 within the face's associated sector.

A controller 74 controls data signal processing and wireless power transmitting of antenna array 70. In various embodiments, controller 74 is programmable digital logic, such as a field programmable gate array (FPGA). Alternatively, controller 74 can be implemented as another programmable logic device, a processor, an application specific integrated circuit (ASIC), a digital signal processor (DSP), a microcontroller, a microprocessor, a processing module, other suitable controller, or a combination thereof. Controller 74 configures antenna array 70 to achieve various radiation patterns for selectively formed signal 38. In various embodiments, controller 74 can adjust various antenna array parameters of antenna array 70 to achieve various radiation patterns for selectively formed signal 38.

A radiation pattern forming mechanism 156 produces (generates) selectively formed signal 38. Radiation pattern forming mechanism 156 can include controller 74, an RF transceiver 78 (in various embodiments, an agile wideband RF transceiver), and a power amplifier and a switch associated with each antenna E1, E2, E3, and E4 (power amplifiers 80 and switches 82). In the depicted embodiment, one power amplifier 80 is associated antenna E1 and antenna E2, and another amplifier 80 is associated with antenna E3 and antenna E4. In furtherance of the depicted embodiment, each antenna E1, E2, E3, and E4 has an associated switch 82. Controller 74 communicates with RF transceiver 78, power amplifiers 80, and switches 82 to achieve various radiation patterns for selectively formed signal 38. For example, controller 74 can provide an input signal to RF transceiver 78, which processes the input signal to provide an RF input signal (also referred to as a carrier signal) to power amplifiers 80. Each antenna E1, E2, E3, and/or E4 can transmit (radiate) respective RF signals 72(1), 72(2), 72(3), and 72(4) responsive to its corresponding amplified transmit signal component, which can combine to produce selectively formed signal 38. In the depicted embodiment, each power amplifier 80 receives an RF signal component from RF transceiver 78 (indicated by solid arrows) and a corresponding component from controller 74 (indicated by dashed arrows) (for example, a programmed, specific component for each antenna of antenna array 70).

Controller 74 can selectively turn antennas E1, E2, E3, and E4 on or off to form various radiation patterns for beam formed signal 38. By adjusting various antenna parameters (such as selectively switching on/off antennas of antenna array 70), REDDA system 36 can selectively charge and/or power on/off sensor nodes 20. For example, where a sensor node 20 has a battery (for example, where sensor node 20 includes an active or semi-passive RFID tag), REDDA system 36 can generate selectively formed signal 38 with a radiation pattern that selectively charges the battery, in some embodiments, to lengthen a lifetime of the battery. The radiation pattern can be adjusted to maximize wireless charging of the battery and optimize a rate of transfer of RF energy to the sensor node 20. In another example, where a sensor node 20 is battery free (for example, where sensor node 20 includes a passive RFID tag), REDDA system 36 can provide selectively formed signal 38 with a radiation pattern that selectively turns on/off the sensor node 20. In some embodiments, the radiation pattern can be adjusted to turn some sensor nodes 20 on while turning other sensor nodes 20 off. The radiation pattern can further be adjusted to maximize wireless power transmission to the sensor nodes 20 to optimize charging and/or powering on time for sensor nodes 20.

In various embodiments, adjusting various antenna parameters to provide selectively formed signal 38 with various radiation patterns provides a programmable quality of service (QoS) metric for wireless power transmission. For example, controller 74 can selectively turn on/off antennas of antenna array 70 to produce radiation patterns for selectively formed signal 38 having different QoS. QoS can refer to a defined level of performance in wireless network system 12 and/or communication system 10. Different radiation patterns of selectively formed signal 38 can achieve different QoS, depending on communication requirements of communication system 10, wireless network system 12, sensor nodes 20, full function device node 22, reduced function device node 24, REDDA system 36, and/or RED system 40. In various embodiments, sensor nodes 20 located in one portion of wireless sensor network 12 may need to receive RF energy with a different QoS than sensor nodes 20 located in another part of wireless sensor network 12. In various embodiments, sensor nodes 20 located in one sector of a portion of defined coverage area 50, such as portion A, may need to receive RF energy with a different QoS than sensor nodes 20 located in another sector of the portion of defined coverage area 50. In various embodiments, full function device node 22 can perform machine health monitoring. In such configurations, a machine may send an alert to full function device node 22 that indicates a problem associated with the machine (for example, the machine may need more power and/or need to increase data transmission frequency). Full function device node 22 can produce a radiation pattern that elevates (increases) QoS of the selectively formed signal 38 received by the machine, such that the machine receives more power and/or full function device node 22 scans the machine more frequently to increase data transmission frequency. Such QoS can remain elevated until resolving any problem associated with the machine. The machine can communicate with full function device node 22 over an IoT port, such as that described below, where the machine can report the problem to the full function device node 22, and notify full function device node 22 when the problem has been resolved.

REDDA system 36 can maximize wireless power transmission based on changes in network environment of its associated portion of defined coverage area 50, such as changes in location of sensor nodes 20, full function device node 20, reduced function nodes 24, RED systems 40, and/or things within and/or around wireless network system 12. For example, REDDA system 36 can evaluate its surrounding network environment to determine an appropriate radiation pattern for selectively formed signal 38 that maximizes wireless power transmission, and thus maximizes wireless charging of sensor nodes 20 within its associated portion, such as portion A, of defined coverage area 50. Different environment parameters can be evaluated based on information collected from sensor nodes 20, network elements within and/or around wireless network system 12, and/or network elements over network 32. In various embodiments, REDDA system 36 can use information to maximize wireless power transmission (for example, maximize RF energy transfer efficiency) to sensor nodes 20. For example, REDDA system 36 can include a memory 84 that stores a table that defines various radiation pattern profiles for selectively formed signal 38, where each profile maximizes wireless power transmission for a given environment associated with sensor nodes 20 in the portion of defined coverage area 50. Each profile can define a radiation pattern for selectively formed signal 38, along with parameters associated with selectively switching antennas of antenna array 70 on/off to achieve the defined radiation pattern. Controller 74 can select a beam profile from the table to maximize wireless power transmission within the portion of defined coverage area 50 for which the REDDA system 36 is responsible for wirelessly transmitting power.

As noted above, full function device node 22 can communicate the collected data to network elements of wireless network system 12 or to network elements over network 32. In FIG. 3, REDDA system 36 also includes an interface 86 that connects REDDA system 36 to network elements within wireless network system 12, such as a network element 88, or to network elements over network 32, such as network element 90. In some embodiments, network element 88 can be connected to network 32. Interface 86 can include an Ethernet interface 92 and/or a universal serial bus (USB) interface 94 for connecting to other networks, network elements, and/or applications. In various embodiments, interface 86 is an IoT interface that connects REDDA system 36 to an IoT system through a wired and/or wireless connection. For example, REDDA system 36 can be connected to the Internet. In various embodiments, network element 88 and/or network element 90 can be implemented as a host computer system that processes information collected from sensor nodes 20 via REDDA system 36. In various embodiments, full function device node 22 can directly communicate with the Internet and/or Internet connected entities and/or with other networks and/or network connected entities (such as a robot network, as described further below) via the IoT interface. In various embodiments, the IoT interface facilitates building a mesh network out of more than one REDDA system 36, where the REDDA systems 36 can communicate with one another and data mine over wireless network system 12. In some embodiments, REDDA system 36 can data mine over wireless network system 12 via the IoT interface to better define an appropriate radiation pattern for selectively formed signal 38. In some situations, REDDA system 36 sets the radiation pattern of the selectively formed signal 38 based on information gleaned from the IoT system. REDDA system 36 can thus set a radiation pattern for selectively formed signal 38 and/or QoS for selectively formed signal 38 based on data mining results from wireless network system 12 and/or based on IoT requests.

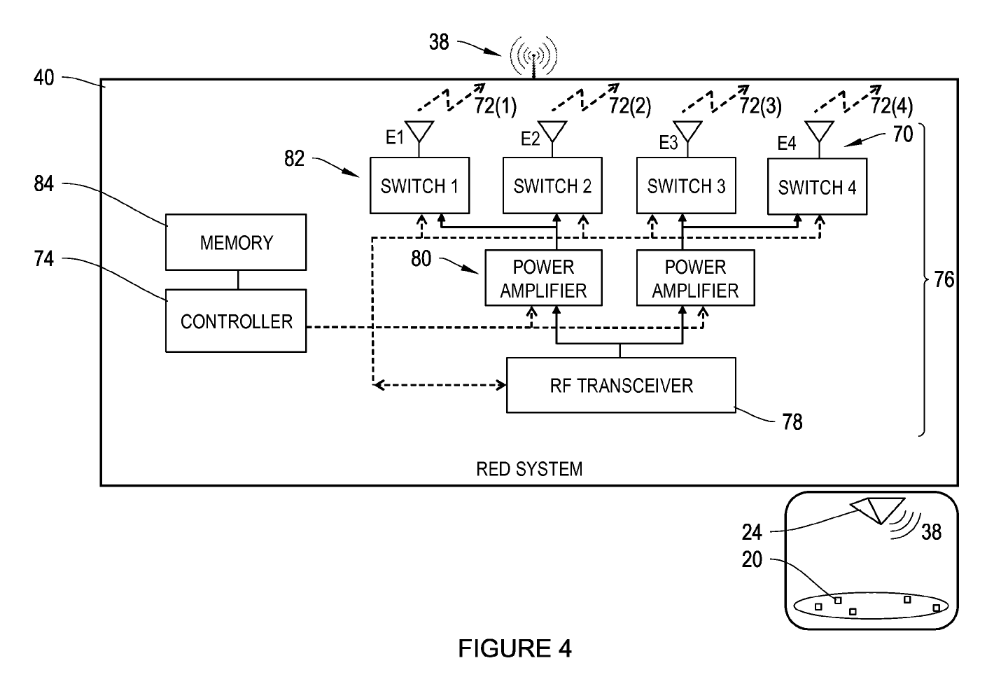

FIG. 4 is a schematic block diagram of an exemplary RED system 40, which can be implemented in reduced function device node 24, according to various aspects of the present disclosure. RED system 40 can be implemented using various distributed integrated circuits and/or devices interconnected with each other, such that components of RED system 40 are integrated to provide the functions described herein. RED system 40 of FIG. 4 is similar in many respects to REDDA system 36 of FIG. 2. Accordingly, similar features in FIG. 3 and FIG. 4 are identified by the same reference numerals for clarity and simplicity. FIG. 4 has been simplified for the sake of clarity to better understand the inventive concepts of the present disclosure. Additional features can be added in RED system 40, and some of the features described can be replaced or eliminated in other embodiments of RED system 40.

Similar to REDDA system 36, RED system 40 includes antenna array 70 having antennas E1, E2, E3, and E4. RED system 40 further includes radiation pattern forming mechanism 156 for producing selectively formed signal 38, which can include controller 74, RF transceiver 78, power amplifiers 80, and switches 82. By adjusting various antenna parameters (such as selectively switching on/off antennas of antenna array 70), RED system 40 can selectively charge and/or power on/off sensor nodes 20 within its assigned portion of defined coverage area 50. For example, where a sensor node has a battery (for example, where sensor nodes 20 includes an active or semi-passive RFID tag), RED system 40 can provide selectively formed signal 38 with a radiation pattern that selectively charges the battery, in some embodiments, to lengthen a lifetime of the battery. The radiation pattern can be adjusted to maximize wireless charging of the battery and optimize a rate of transfer of RF energy to sensor nodes 20. In another example, where a sensor node is battery free (for example, where sensor nodes 20 includes a passive RFID tag), RED system 40 can provide selectively formed signal 38 with a radiation pattern that selectively turns on/off the sensor nodes 20. In some embodiments, the radiation pattern can be adjusted to turn some sensor nodes 20 on while turning other sensor nodes 20 off. The radiation pattern can further be adjusted to maximize wireless power transmission to the sensor nodes 20, optimizing charging and/or powering on time.

In contrast to REDDA system 36, RED system 40 only wirelessly transmits power, without data aggregation functionality. Accordingly, controller 74 can be much simpler in RED system 40 than REDDA system 36. The simpler configuration of RED system 40 can significantly decrease costs for achieving the network topology described herein. For example, in various embodiments, an Xilinx Zynq®-7000 All Programmable processor can be implemented in REDDA system 36, while an ARM® Cortex®-M3 based processor can be implemented in RED system 40. Furthermore, when compared to REDDA system 36, an RF transceiver of REDDA system 36 has greater sensitivity than an RF transceiver of RED system 40. In various embodiments, for example, a wide band transceiver, such as an RF transceiver from Analog Devices, Inc.'s AD936x family (in some implementations, AD9364), can be implemented in REDDA system 36, while a narrow band transceiver, such as an RF transceiver from Analog Devices, Inc.'s ADF7xxx family (in some implementations, ADF7242), can be implemented in RED system 40. In various embodiments, REDDA system 36 can aggregate data from sensor nodes 20 within about 25 meters of REDDA system 36, whereas RED system 40 can wirelessly transmit power to sensor nodes within about 5 meters of RED system 40. In various embodiments, RED system 40 may not include an IoT interface and/or connectivity, as in the depicted embodiment, though the present disclosure contemplates implementations where RED system 40 includes an IoT interface and/or connectivity. In various embodiments, REDDA system 36 communicates with RED systems 40. In some embodiments, REDDA system 36 may recognize that is unable to communicate with one of sensor nodes 20 (for example, where the sensor node is no longer periodically communicating with REDDA system 36). Such halt in communication may result from the sensor node being turned off or needing charging. In such situations, REDDA system 36 can communicate with RED systems 40 that can turn the sensor node on and/or selectively charge the sensor node. In some embodiments, REDDA system 36 can communicate with RED systems 40 to achieve various radiation patterns for turning on and/or charging the sensor node.

The present disclosure also contemplates embodiments that eliminate reduced function device nodes 24 and/or RED systems 40. In such implementations, communications systems can implement a wireless networked system solution that combines a gateway node (configured with REDDA system 36) and ultra-low power sensor nodes, described below. The disclosed gateway node is configured to generate and distribute RF radiation patterns (also referred to as RF energy streams) that deliver a consistent energy source while maximizing transmission range as well as coverage area.

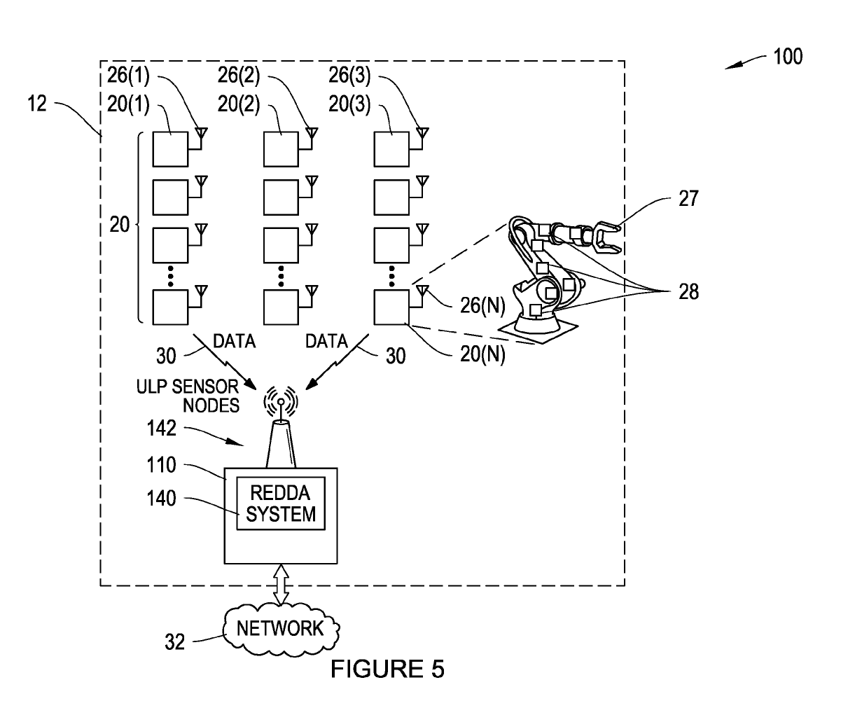

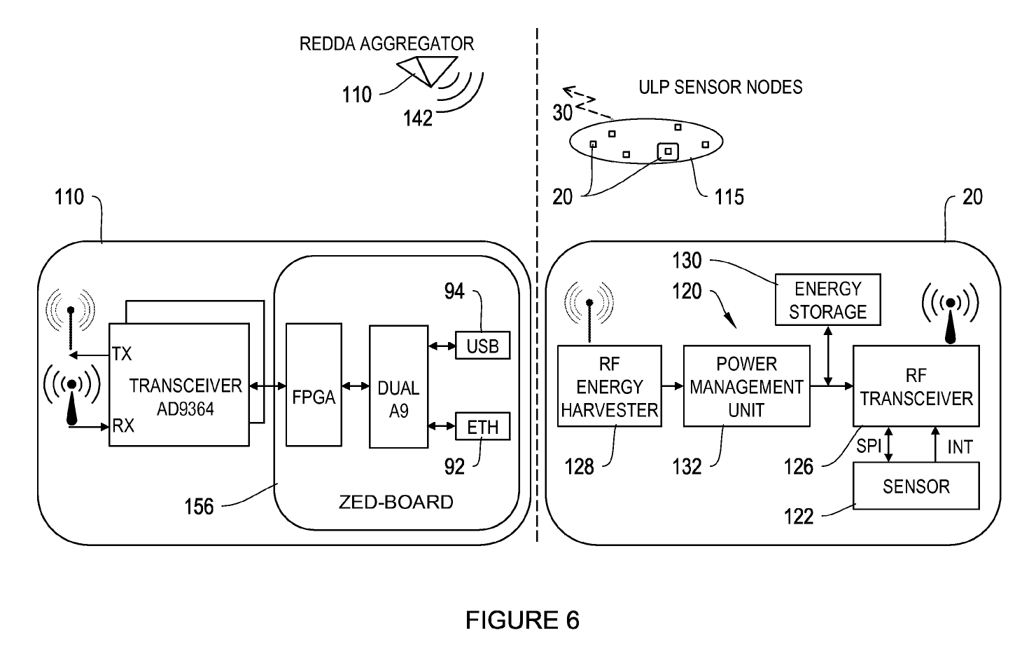

FIG. 5 and FIG. 6 are schematic block diagrams of another exemplary communications system 100 for optimizing wireless charging (also referred to as wireless power transmission) in a network environment according to various aspects of the present disclosure. Communications system 100 can be implemented for in process control and automation applications, for example, a process control and automation system for performing targeted machine monitoring and/or state-of-health applications. Communications system 100 of FIG. 5 and FIG. 6 is similar in many respects to communications system 10 of FIG. 1 and FIG. 2. Accordingly, similar features in FIG. 5 and FIG. 6 are identified by the same reference numerals depicted in FIG. 1 and FIG. 2 for clarity and simplicity. FIG. 5 and FIG. 6 have been simplified for the sake of clarity to better understand the inventive concepts of the present disclosure. Additional features can be added in communications system 100, and some of the features described herein can be replaced or eliminated in other embodiments of communications system 100.

In FIG. 5 and FIG. 6, communications system 100 includes wireless network system 12, which includes sensor nodes 20 that communicate wirelessly with a gateway node 110 (similar in many respects to full function device 22 described above). Gateway node 110 wirelessly aggregates data from sensor nodes 20 (including from each sensor 28) via data signals 30. Each sensor node 20 can collect data from an environment local to the sensor node 20 and packetize the collected data for transmission to gateway node 110. Sensor nodes 20 can be distributed throughout a location, for example, within and/or around a building, such as a warehouse, where gateway node 110 can track information associated with the building or objects, people, animals, and/or entities associated with the building. In the depicted embodiment, wireless network system 12 can include hundreds or even thousands of sensor nodes 20, where gateway node 110 aggregates data from and wirelessly transmits power to sensor nodes 20 within a defined coverage area 115 (FIG. 6) of wireless network system 12. Gateway node 110 can be mounted to a wall and/or ceiling associated with the location where the sensor nodes 22 are distributed, such as within and/or around a building. In some embodiments, defined coverage area 115 covers wireless network system 12 in its entirety. However, the present disclosure contemplates embodiments having more than one gateway node 110, where each gateway node 110 aggregates data from and wirelessly transmits power to sensor nodes 20 within various defined coverage areas of wireless network system 12. Gateway node 110 wirelessly communicates with sensor nodes 20 using any appropriate communication standard, and gateway node 110 can communicate the collected data to network elements of wireless network system 12 or to network elements over network 32.

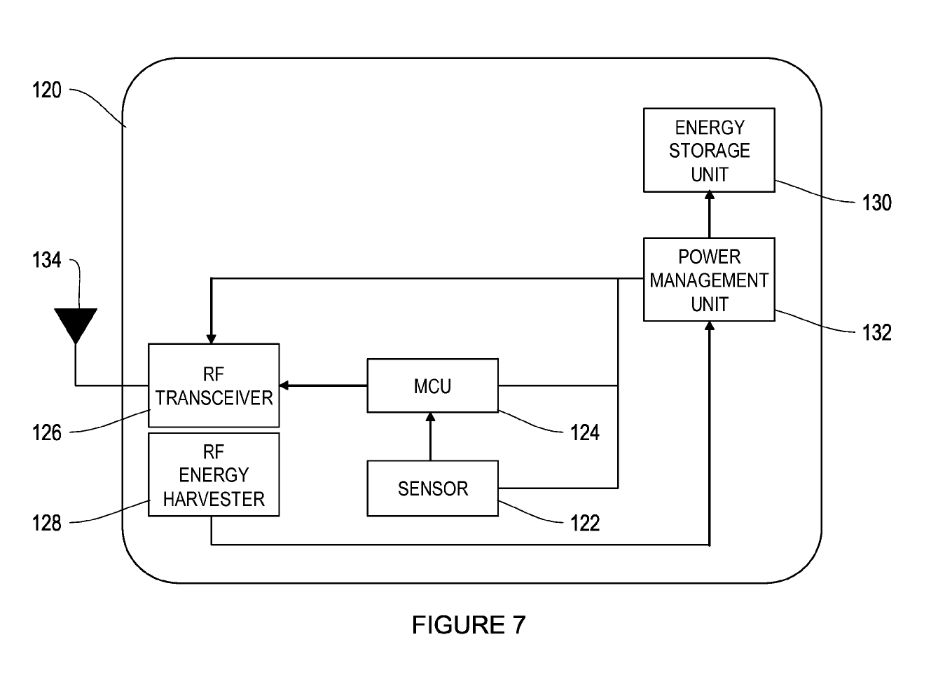

As described further below, sensor nodes 20 wirelessly derive at least a portion of power from gateway node 110, particularly from RF energy transmitted by gateway node 110. Each sensor node 20 can include an energy harvesting mechanism for deriving, capturing, and storing RF energy from gateway node 110. Sensor nodes 20 can operate solely off RF energy harvested from gateway node 110 or from a battery charged by RF energy harvested from gateway node 110. Sensor nodes 20 may be configured as ultra-low power sensor nodes. FIG. 7 is a schematic block diagram of an exemplary sensor node 120 that can achieve ultra-low power operation, which can be implemented by sensor nodes 20, according to various aspects of the present disclosure. Sensor node 120 can be implemented using various distributed integrated circuits and/or devices interconnected with each other, such that components of sensor node 120 are integrated to provide the functions described herein. Sensor node 120 includes a sensor 122, a processor 124 (such as a microcontroller unit (MCU)), an RF transceiver 126, an RF energy harvester 128, an energy storage unit 130, a power management unit 132 (which may be provided by Analog Devices, Inc., such as ADI's ADP5090 ultra-low power post regulator), and an antenna 134 (in some implementations, a high gain antenna). Sensor 122 can be motion, vibration, temperature, pressure, and/or other measurement parameter based. In some implementations, sensor 122 may be an ultra-low power sensor provided by Analog Devices, Inc., such as ADI's ADXL362 MEMS accelerometer, which exhibits industry-leading power consumption specifications. In various implementations, to reduce overall energy consumption, such as in a half-duplex communication model, sensor node 120 can operate without an RF receiver. In such implementations, RF transceiver 126 can be replaced with a RF transmitter only, such as a sub-gigahertz ultra-low power narrow band transmitter. FIG. 7 has been simplified for the sake of clarity to better understand the inventive concepts of the present disclosure. Additional features can be added in sensor node 120, and some of the features described can be replaced or eliminated in other embodiments of sensor node 120.

Returning to FIG. 5 and FIG. 6, as noted, gateway node 110 can aggregate data collected by sensor nodes 20, and can wirelessly charge sensor nodes 20, for example, by wirelessly transmitting power to sensor nodes 20. Gateway node 110 includes a REDDA system 140 (similar in many respects to REDDA system 36) that aggregates data from sensor nodes 20 and wirelessly transmits power to sensor nodes 20 using a selectively formed signal 142, such that sensor nodes 20 can operate using energy harvested from selectively formed signal 142. In contrast to REDDA system 36, REDDA system 140 includes an optimized RF signal chain for seamlessly integrating into various applications, wirelessly aggregating monitored data from and remotely transmitting power to sensor nodes operating at various frequency bands deployed within defined coverage area 115. In communications system 100, REDDA system 140 can intelligently schedule data aggregation and wireless power transmission among sensor nodes 20 according to various time, frequency, and modulation schemes. In various embodiments, as described further below, REDDA system 140 can implement an agile wideband transceiver that can aggregate data from sensor nodes 20 and wirelessly transmit power to sensor nodes 20 on different frequency bands, including different ISM and/or non-ISM frequency bands. REDDA system 140 can thus operate at any frequency band of interest, achieving versatile interoperability and plug-in-play capabilities for various wireless sensor networks and applications. For example, REDDA system 140 can receive data signals 30 from sensor nodes 20 on various different frequency bands, and wirelessly transmit power via selectively formed signal 142 to sensor nodes 20 on different frequency bands. Using different frequency bands for aggregating and transmitting can prevent (or minimize) collision of data signals 30 and/or selectively formed 142 and/or minimize data retransmission. For example, instead of aggregating data in a round-robin fashion, REDDA system 140 can simultaneously aggregate data from different sensor nodes 20 on multiple narrowband channels, which can minimize communication latency. REDDA system 140 is also configured to achieve various modulation schemes, including but not limited to, direct-sequence spread spectrum (DSSS), orthogonal frequency division multiplexing (OFDM), frequency shift keying (FSK), phase-shift keying (PSK), amplitude-shift keying (ASK), quadrature amplitude modulation (QAM), minimum-shift keying (MSK), and/or other modulation schemes.

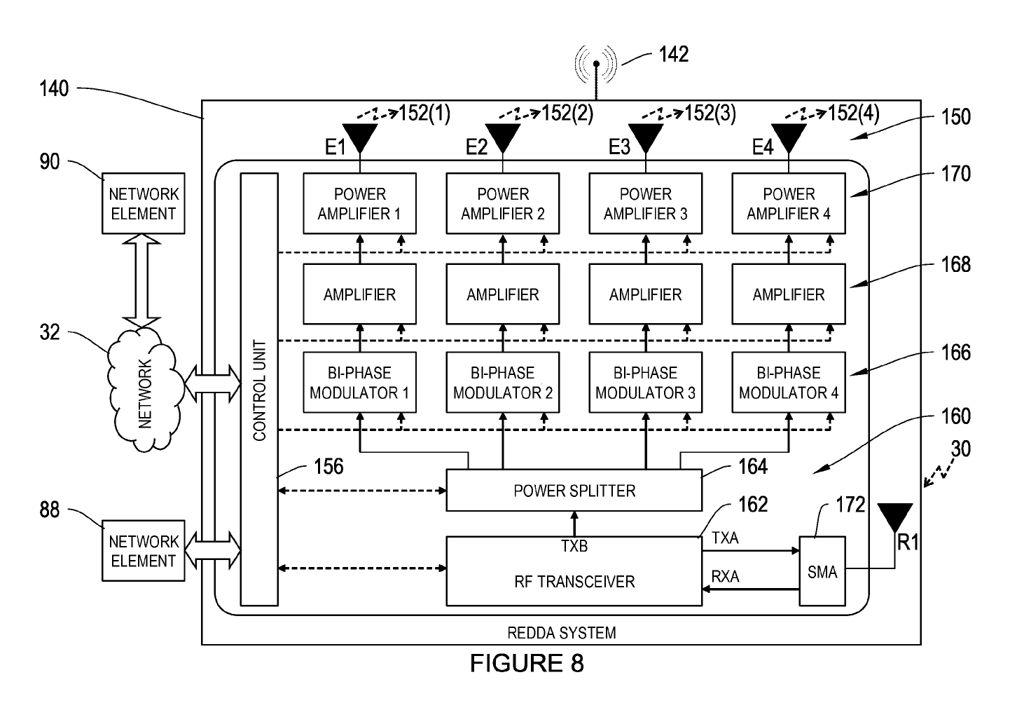

FIG. 8 is a schematic block diagram of an exemplary REDDA system 140, which can be implemented in gateway node 110, according to various aspects of the present disclosure. REDDA system 140 can be implemented using various distributed integrated circuits and/or devices interconnected with each other, such that components of REDDA system 140 are integrated to provide the functions described herein. FIG. 8 has been simplified for the sake of clarity to better understand the inventive concepts of the present disclosure. Additional features can be added in REDDA system 140, and some of the features described can be replaced or eliminated in other embodiments of REDDA system 140.

In FIG. 8, REDDA system 140 includes an antenna array 150 having multiple antennas (elements) E1, E2, E3, and E4 that transmit associated RF signals 152(1), 152(2), 152(3), and 152(4) (collectively referred to as RF signals 152) having various radiation pattern, where the various radiation patterns combine to form a radiation pattern for selectively formed signal 142. REDDA system 140 can tune the radiation pattern for selectively formed signal 142 to optimize wireless power transmission. REDDA system 140 also includes an antenna that receives RF signals, such as antenna R1 for receiving and aggregating data signals 30 from sensor nodes 20. Alternatively, in some embodiments, antennas E1, E2, E3, and/or E4 can be configured for both receiving data from and wirelessly transmitting power to sensor nodes 20. In various implementations, REDDA system 140 includes a single antenna for receiving data signals 30 to collect information from sensor nodes 20. Alternatively, REDDA system 140 can include more than one antenna for receiving data signals 30. Antenna array 150 can include a linear array, a circular array, a planar array, a conformal array, or other type of array. In various embodiments, each antenna E1, E2, E3, and E4 is associated with a defined sector of defined coverage area 115, where each antenna E1, E2, E3, and E4 wirelessly transmits power to sensor nodes 20 within its respective defined sector. In various embodiments, antennas E1, E2, E3, and E4 can have adjacent or overlapping sectors depending on design considerations. In some implementations, each antenna E1, E2, E3, and E4 has an angle of coverage of at least 60 degrees. In some implementations, each antenna E1, E2, E3, and E4 has an angle of coverage of 90 degrees, thereby providing a full 360 degrees coverage.

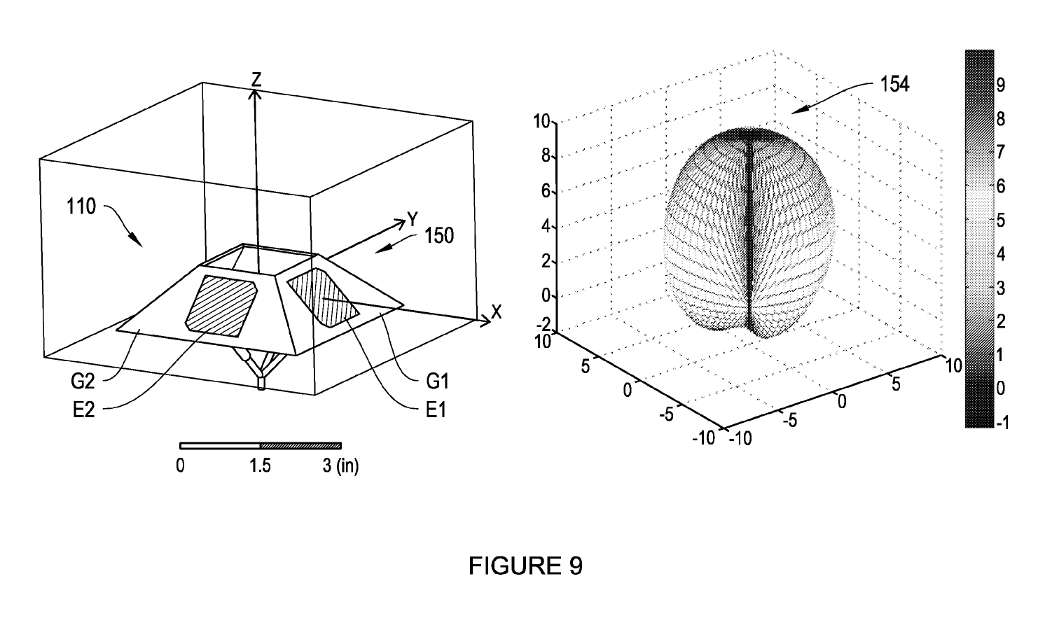

Gateway node 110 is configured to achieve a radiation pattern for selectively formed signal 142 that exhibits a full spread of uniform RF energy with sufficiently high gain, even between adjacent antennas 152 of antenna array 150. In some implementations, gateway node 110 is a pyramid-shaped device having four faces, where each face is associated with one of antennas E1, E2, E3, and E4 for powering (wirelessly charging) sensor nodes 20 within the face's respective sector. FIG. 9 is a schematic block diagram of an exemplary pyramid-shaped gateway node, which can be implemented by gateway node 110, according to various aspects of the present disclosure. In FIG. 9, gateway node 110 includes a pyramid-structured antenna array, which can be mounted to a ceiling and/or wall. Pyramid-structured antenna array 150 has a pyramid-shaped ground board formed by four pyramid-shaped ground planes, G1, G2, G3, and G4, where each ground plane G1, G2, G3, and G4 has an associated antenna patch mounted thereto. For example, antenna E1, E2, E3, and E4 can be configured as antenna patches mounted respectively to ground planes G1, G2, G3, and G4. FIG. 9 has been simplified for the sake of clarity to better understand the inventive concepts of the present disclosure. Additional features can be added in pyramid-shaped gateway node, and some of the features described can be replaced or eliminated in other embodiments of pyramid-shaped gateway node.

Typically, an antenna array is fed with a carrier signal (also referred to as a carrier wave), where each antenna E1, E2, E3, and E4 is fed an exact same signal to produce a selectively formed signal for efficiently reaching sensor nodes 20. In such implementations, destructive interference often occurs between radiation patterns generated by adjacent antennas, resulting in a radiation pattern having minimal to no gain at its edges, thereby diminishing strength of the selectively formed signal delivered to sensor nodes 20 located proximate to edges of the radiation pattern. To overcome such phenomena, gateway node 110 is configured to feed antenna array 150 with a spread-spectrum signal, where each antenna E1, E2, E3, and E4 is fed with different spread-spectrum signals. Feeding antenna array 150 with a spread-spectrum signal, particularly an orthogonal spread-spectrum signal, substantially reduces (and sometimes eliminates) destructive interference between adjacent antennas of antenna array 150, achieving a substantially uniform radiation pattern for selectively formed signal 142. REDDA system 140 can thus generate a radiation pattern for selectively formed signal 142 that uniformly maximizes RF energy distribution to sensor nodes 20. For example, an exemplary gain pattern 154 associated with a radiation pattern of selectively formed signal 142 when antenna array 150 is fed with an orthogonal spread spectrum signal illustrates that a full spread of uniform energy with sufficiently high gain is achieved, even at edges of the radiation pattern. In a main region of interest (for example, 0 degrees ≦θ≦75 degrees), selectively formed signal 142 can achieve a gain of as much as 6+ dBi when pyramid-structured antenna array 150 is fed with an orthogonal spread-spectrum signal. For θ≦40 degrees, selectively formed signal 142 can achieve a gain of as much as 9+ dBi. REDDA system 140 can tune various parameters associated with a Friis Equation to optimize gain of selectively formed signal 142. The Friis Equation is given by:

$$\frac{{P}_{r}}{{P}_{t}} = {G}_{t} {{G}_{r} ( \frac{λ}{4 π R} )}^{2}$$

where Gt is a gain associated with a transmitting antenna, Gr is a gain associated with a receiving antenna, λ is a wavelength, R is a distance between the antennas, Pr is a power available at an input of the receiving antenna, and Pt is an output power available to the transmitting antenna. By tuning various parameters of the Friis equation, REDDA system 140 can optimize the gain, Gt, of the transmitting antenna.

Returning to FIG. 5, FIG. 6, and FIG. 8, a control unit 156 controls data signal processing and wireless power transmitting of antenna array 150. In various embodiments, control unit 156 includes programmable digital logic, such as a field programmable gate array (FPGA). Alternatively, control unit 156 can be implemented as another programmable logic device, a processor, an application specific integrated circuit (ASIC), a digital signal processor (DSP), a microcontroller, a microprocessor, a processing module, other suitable controller, or a combination thereof. In various implementations, control unit 156 can include a motherboard and a daughterboard with an FPGA mezzanine card (FMC) connector. The motherboard can include programmable digital logic (such as FPGA), a processor (such as a dual-core ARM Cortex A9 processor), a memory, and an interface (for example, an interface that includes an Ethernet port, such as Ethernet port 92, and/or USB port, such as USB port 94). In various implementations, the motherboard can be implemented as a ZedBoard. Control unit 156 configures antenna array 150 to achieve various radiation patterns for selectively formed signal 142. In various embodiments, as described further below, controller 156 adjusts various antenna array parameters of antenna array 150 to achieve various radiation patterns for selectively formed signal 142.

A radiation pattern forming mechanism 160 for producing selectively formed signal 142, which can include control unit 156, an RF transceiver 162 (in various embodiments, an agile wideband RF transceiver), a power splitter 164, and a bi-phase modulator, an amplifier, and a power amplifier associated with each antenna E1, E2, E3, and E4 (bi-phase modulators 166, amplifiers 168, and power amplifiers 170). For example, control unit 156 can provides an input signal to RF transceiver 162, which processes the input signal to provide an RF input signal (also referred to as a carrier signal) to power splitter 164, which can split (or divide) the RF input signal into various RF signal components (here, four RF signal components). In various embodiments, a processing stage associated with each antenna E1, E2, E3, and E4 of antenna array 150 receives an RF signal component from power splitter 164. Each bi-phase modulator 82 receives a corresponding RF signal component from power splitter 164 (indicated by solid arrows) and a corresponding modulation component from control unit 156 (indicated by dashed arrows). Each bi-phase modulator 166 then introduces its corresponding modulation component, a different spread-spectrum sequence (such as a different orthogonal spread-spectrum sequence) into its corresponding RF signal component to produce modulated transmit signal components, which are provided to respective amplifiers 168 and respective power amplifiers 170. Each antenna E1, E2, E3, and E4 of antenna array 150 is thus fed a differently modulated transmit signal component. By implementing bi-phase modulators 80 and/or power amplifiers 86, gateway node 110 can feed antenna array 150 an orthogonal spread-spectrum signal, which as noted above, can achieve uniform radiation patterns for antenna array 150. Each antenna E1, E2, E3, and/or E4 can transmit (radiate) respective RF signals 152(1), 152(2), 152(3), and 152(4) responsive to its corresponding amplified, modulated transmit signal component. In some implementations, the wideband transceiver is one from Analog Device Inc.'s AD936x family, such as RF Agile Transceiver AD9364 (described in detail in AD9364 Data Sheet, which is hereby incorporated herein by references). In some implementations, the bi-phase modulator is one from Hittite Microwave Corporation. For example, the bi-phase modulator is implemented by Hittite's HMC175MS8 miniature double-balanced mixer. In some implementations, the power amplifier is one from Hittite Microwave Corporation, such as Hittite's HMC755LP4E power amplifier and/or Hittite's HMC308 amplifier.

The optimized RF signal chain (wideband RF transceiver in conjunction with the power splitter, bi-phase modulator, power amplifier, and antenna) maximizes uniform transmission of RF energy to sensor nodes 20 deployed within defined coverage area 115, ensuring that a same power (uniform strength) is transmitted by selectively formed signal 142 to a sensor node irrespective of a location of the sensor node within the defined coverage area 115. As noted above, the optimized RF signal chain eliminates or substantially reduces destructive interference at edges of the radiation pattern of selectively formed signal 142. Since feeding the antenna array with an orthogonal spread-spectrum signal maximizes uniformity of the radiation pattern of selectively formed signal 142, REDDA system 140 can wirelessly transmit power to sensor nodes 20 without using an uplink communication link from sensor nodes 20 to gather three-dimensional location information associated with sensor nodes 20. Accordingly, so long as a sensor node is within a radiation pattern of selectively formed signal 142 (such as a sphere of uniform RF energy), the sensor node can harvest RF energy from gateway node 20.

By adjusting various antenna parameters, REDDA system 140 can selectively charge and/or power on/off sensor nodes 20. For example, where a sensor node 20 has a battery (for example, where sensor node 20 includes an active or semi-passive RFID tag), REDDA system 140 can provide selectively formed signal 142 with a radiation pattern that selectively charges the battery, in some embodiments, to lengthen a lifetime of the battery. The radiation pattern can be adjusted to maximize wireless charging of the battery and optimize a rate of transfer of RF energy to the sensor node 20. In another example, where a sensor node 20 is battery free (for example, where sensor node 20 includes a passive RFID tag), REDDA system 140 can provide selectively formed signal 142 with a radiation pattern that selectively turns on/off the sensor node 20. In some embodiments, the radiation pattern can be adjusted to turn some sensor nodes 20 on while turning other sensor nodes 20 off. The radiation pattern can further be adjusted to maximize wireless power transmission to the sensor nodes 20 to optimize charging and/or powering on time for sensor nodes 20.

In various embodiments, adjusting various antenna parameters to provide selectively formed signal 142 with various radiation patterns provides a programmable QoS metric for wireless power transmission. For example, control unit 156 can selectively tune a radiation pattern of antenna array 150 to produce radiation patterns for selectively formed signal 142 having different QoS. QoS can refer to a defined level of performance in wireless network system 12 and/or communication system 10. Different radiation patterns of selectively formed signal 142 can achieve different QoS, depending on communication requirements of communication system 10, wireless network system 12, sensor nodes 20, gateway node 110, and/or REDDA system 140. In various embodiments, sensor nodes 20 located in one portion of wireless sensor network 12 may need to receive RF energy with a different QoS than sensor nodes 20 located in another part of wireless sensor network 12. In various embodiments, sensor nodes 20 located in one portion of defined coverage area 115, may need to receive RF energy with a different QoS than sensor nodes 20 located in another portion of defined coverage area 115. In various embodiments, gateway node 110 can be configured for machine health monitoring. In such configurations, a machine may send an alert to gateway node 110 that indicates a problem associated with the machine (for example, the machine may need more power and/or increase data transmission frequency). Gateway node 110 can produce a radiation pattern that elevates (increases) QoS of the selectively formed signal 142 received by the machine, such that the machine receives more power and/or gateway node 110 scans the machine more frequently to increase data transmission frequency. Such QoS can remain elevated until resolving the problem associated with the machine. In various embodiments, the machine can communicate with gateway node 110 over an IoT port, such as that described below, where the machine can report the problem to the gateway node 110, and notify gateway node 110 when the problem has been resolved.

In various embodiments, REDDA system 140 can maximize wireless power transmission based on changes in network environment of its associated portion of defined coverage area 115, such as changes in location of sensor nodes 20, gateway node 110, and/or things within and/or around wireless network system 12. For example, REDDA system 140 can evaluate its surrounding network environment to determine an appropriate radiation pattern for selectively formed signal 142 that maximizes wireless power transmission, and thus maximizes wireless charging of sensor nodes 20 within its defined coverage area 115. Different environment parameters can be evaluated based on information collected from sensor nodes 20, network elements within and/or around wireless network system 12, and/or network elements over network 32. In various embodiments, REDDA system 140 can use information to maximize wireless power transmission (for example, maximize RF energy transfer efficiency) to sensor nodes 20. For example, REDDA system 140 can include a memory that stores a table that defines various radiation pattern profiles for selectively formed signal 142, where each profile maximizes wireless power transmission for a given environment associated with sensor nodes 20 in defined coverage area 115. In various embodiments, each profile defines a radiation pattern for selectively formed signal 142. Control unit 156 can select a beam profile from the table to maximize wireless power transmission within defined coverage area 115 for which the REDDA system 140 is responsible for wirelessly transmitting power.

As noted above, gateway node 110 can communicate the collected data to network elements of wireless network system 12 or to network elements over network 32. In FIGS. 5, 6, and 8, REDDA system 140 can also include an interface that connects REDDA system 140 to network elements within wireless network system 12, such as network element 88, or to network elements over network 32, such as network element 90. The interface can include an Ethernet interface and/or a universal serial bus (USB) interface for connecting to other networks, network elements, and/or applications. In various embodiments, the interface is an IoT interface that connects REDDA system 140 to an IoT system through a wired and/or wireless connection. For example, REDDA system 140 can be connected to the Internet. In various embodiments, network element 88 and/or network element 90 can be implemented as a host computer system that processes information collected from sensor nodes 20 via REDDA system 140. In various embodiments, gateway node 110 can directly communicate with the Internet and/or Internet connected entities and/or with other networks and/or network connected entities (such as a robot network, as described further below) via the IoT interface. In various embodiments, gateway node 110 is configured to support 6LoWPAN (IPv6 over Low Power Wireless Personal Area Network) and IPv6 (Internet Protocol version 6) network protocols. In various embodiments, the IoT interface facilitates building a mesh network out of more than one REDDA system 140, where the REDDA systems 140 can communicate with one another and data mine over wireless network system 12. In some embodiments, REDDA system 140 can data mine over wireless network system 12 via the IoT interface to better define an appropriate radiation pattern for selectively formed signal 142. In some situations, REDDA system 140 sets the radiation pattern of the selectively formed signal 142 based on information gleaned from the IoT system. REDDA system 140 can thus set a radiation pattern for selectively formed signal 142 and/or QoS for selectively formed signal 142 based on data mining results from wireless network system 12 and/or based on IoT requests.

Aspects of communications system 10, communications system 100, and/or wireless network system 12 described herein are particularly useful in industrial applications. Critical industrial infrastructure, such as process control and automation factory settings, typically require around-the-clock monitoring and 24/7 operation of end equipment. Such monitoring/operation applications currently deploy wired sensor networks because of a strong aversion to increased operating costs and potential production down time related to battery replacement within wireless sensor networks. Delivering a battery-less or battery-assisted wireless sensor network can save millions of dollars in operating expenses and lost production time over the life of a monitoring/operation applications network deployment. As such, the REDDA systems described herein can provide many benefits to industrial applications hoping to shift monitoring/operating networks from wired to wireless topologies, enabling an increased number of sensor deployments, enhanced network flexibility, and elimination of typical battery operated sensor node pitfalls.

Aspects of communications system 10, communications system 100, and/or wireless network system 12 described herein can also be particularly useful in aerospace and/or aviation applications to avoid interference with periodic signals transmitted within aerospace and/or aviation environments. For example, an aircraft (or spacecraft) can be configured with sensor nodes 20 for collecting data from various electrical systems, mechanical systems, control systems, thermal systems, and/or other systems associated with the aircraft, where gateway node 110 can wirelessly aggregate data associated with the aircraft from sensor nodes 20 and/or wirelessly power sensor nodes 20 while the aircraft is in flight. Gateway node 110 and/or sensor nodes 20 can be configured to continuously access maintenance data around the aircraft. By implementing wireless data aggregation and/or wireless charging schemes in aircraft control and monitoring applications, aircraft wiring can be significantly reduced, significantly reducing aircraft weight, which can significantly reduce fuel costs. In such applications, gateway node 110 and sensor nodes 20 cannot operate using ISM frequency bands because doing so would interfere with the aircraft's operations. Gateway node 110 and sensor nodes 20 can thus be configured to operate in a non-ISM frequency band. For example, gateway node 110 and sensor nodes 20 can be configured to operate at a frequency band reserved for a radio altimeter associated with the aircraft, such as from about 4.2 GHz (a low frequency, F_{L}) to about 4.4 GHz (a high frequency, F_{H}). The radio altimeter measures an altitude above a surface (such as terrain or ground) beneath the aircraft by timing how long it takes an RF signal to reflect from the surface to the aircraft. The radio altimeter can convert a time difference between transmitted RF signals and received (reflected) RF signals. To ensure that the radio altimeter and/or other aviation components can operate properly, gateway node 110 and sensor nodes 20 are configured to co-exist seamlessly with the aviation and/or aerospace environment.

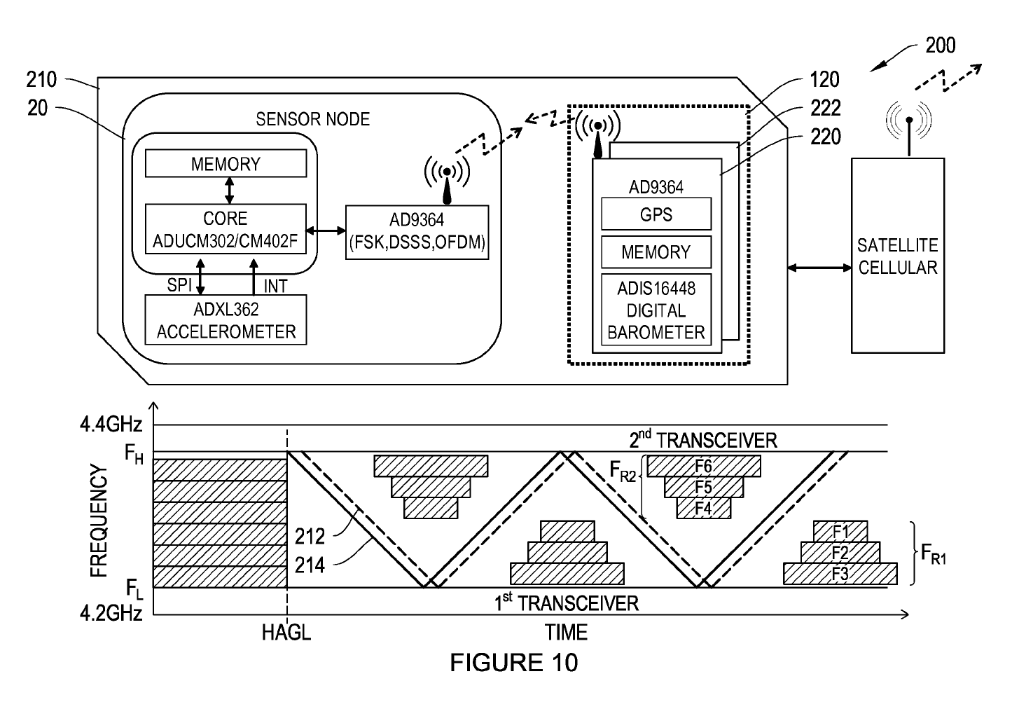

FIG. 10 is a schematic diagram of an exemplary wireless avionics intra-communication (WAIC) network environment 200 according to various aspects of the present disclosure. WAIC network 200 can be implemented for avionic monitoring and automation applications implemented by aircraft (or spacecraft), such as aircraft 210. A radio altimeter associated with aircraft 210 can provide an aircraft's height above terrain from 0 to a height above ground level (HAGL). In some implementations, the height above ground level is about 4,500 meters. The radio altimeter sweeps frequencies from a low radio altimeter frequency, F_{L}, (such as about 4.2 GHz) to a high radio altimeter frequency, F_{H} (such as about 4.4 GHz). In FIG. 10, the radio altimeter's frequency sweeps are depicted as triangular frequency sweeps, where transmitted radio altimeter signals are depicted by dashed line 212, and received (reflected) radio altimeter signals are depicted by solid line 214. FIG. 10 has been simplified for the sake of clarity to better understand the inventive concepts of the present disclosure. Additional features can be added in WAIC network 200, and some of the features described herein can be replaced or eliminated in other embodiments of WAIC network 200.

In WAIC network 200, up to the height above ground level, gateway node 110 is configured to track radio altimeter signals and intelligently schedule data aggregation and wireless power transmission activities in a manner that avoids interference with the radio altimeter signals, allowing gateway node 110 and sensor nodes 20 to operate seamlessly with the radio altimeter while aircraft 210 is in flight. Above the height above ground level, when the radio altimeter is no longer operating, gateway node 110 and sensor nodes 20 can continue to operate in the radio altimeter frequency band, such that gateway node 110 and sensor nodes 20 operate seamlessly with aircraft 210 while in flight. To achieve such operation, gateway node 110 includes at least two RF transceivers, such as a RF transceiver 220 and a RF transceiver 222, which operate in an alternating manner. RF transceiver 220 and a RF transceiver 222 alternate between tracking of the frequency of the periodic signal and aggregating data from sensor nodes 20. When RF transceiver 220 tracks the radio altimeter signal, RF transceiver 222 aggregates data from sensor nodes 220. When RF transceiver 222 tracks the radio altimeter signal, RF transceiver 220 aggregates data from sensor nodes 220.

RF transceiver 220 and RF transceiver 222 are agile wideband transceivers, such as RF agile transceivers from Analog Devices Inc.'s AD9140x family (in some implementations, AD91404). RF transceiver 220 and RF transceiver 222 are configured to operate in respective frequency bands that can optimize wireless aggregation and power transmission in flight, while providing a safe operating gap between the radio altimeter and the RF transceivers. For example, RF transceiver 220 operates in a frequency band F_{R1} that ranges from low radio altimeter frequency F_{L} to some frequency above low radio altimeter frequency F_{L}, and RF transceiver 222 operates in a frequency band F_{R2} that ranges from high radio altimeter frequency F_{H} to some frequency below high radio altimeter frequency F_{H}. In some implementations, the RF transceivers can operate in a 200 MHz frequency range, where RF transceiver 220 operates from low radio altimeter frequency F_{L} to a frequency about 200 MHz greater than the low radio altimeter frequency F_{L}, and RF transceiver 222 operates in a frequency band that ranges from high radio altimeter frequency F_{H} to a frequency about 200 MHz less than high radio altimeter frequency F_{H}. Accordingly, when radio altimeter is operating at or near low radio altimeter frequency F_{L}, gateway node 110 can aggregate data and wirelessly transmit power using RF transceiver 222, which operates in a frequency range near high radio altimeter frequency F_{H}, and when radio altimeter is operating at or near high radio altimeter frequency F_{H}, gateway node 110 can aggregate data and wirelessly transmit power using RF transceiver 220, which operates in a frequency range near low radio altimeter frequency F_{L}. Since RF transceiver 220 and RF transceiver 222 can operate in an alternating manner, gateway node 110 can avoid interference with radio altimeter signals, and thus, seamlessly operate with the radio altimeter at the radio altimeter frequency band. In some implementations, gateway node 110 implements as many RF transceivers as necessary to track and aggregate data across the radio altimeter frequency band. Though the present example involves the radio altimeter, the present disclosure contemplates gateway node 110 tracking a frequency of any periodic signal sweeping a defined frequency band within the aviation environment and scheduling data aggregation on a frequency band within the defined frequency band based on the tracked frequency.

In FIG. 10, RF transceiver 220 and RF transceiver 222 can implement various multiplexing techniques to split associated frequency bands into smaller frequency bands (channels) using frequency, time, and/or modulation schemes. The multiplexing techniques can include frequency division multiple access (FDMA), time-division multiplexing (such as time-division multiple access (TDMA)), code-division multiplexing (such as code-division multiple access (CDMA)), a combination thereof, and/or other multiplexing techniques. In the present example, as the radio altimeter approaches operation near the operating frequency band for RF transceiver 220 or RF transceiver 222, the RF transceivers decrease an amount of time allocated for aggregating data and transmitting power at such frequencies. For example, in various implementations, RF transceiver 220 divides its associated frequency band F^{R1} into three frequency bands (channels), F1, F2, and F3, and RF transceiver 222 divides its associated frequency band F_{R2} into three frequency bands (channels) F4, F5, and F6. For RF transceiver 220, in the depicted embodiment, each frequency band F1, F2, and F3 is associated with a different time frame, where a time for operating at each frequency decreases as the frequency increases. For RF transceiver 222, in the depicted embodiment, each frequency band F4, F5, and F6 is associated with a different time frame, where a time for operating at each frequency increases as the frequency increases. Each frequency band F1, F2, F3, F4, F5, and F6 can be associated with a different or a same modulation scheme.

By tracking radio altimeter signals, gateway node 110 can schedule data aggregation from and wireless transmission to sensor nodes 20 based on time, frequency, and/or modulation. In some implementations, gateway node 110 can schedule a time, frequency, and/or modulation scheme for each sensor node 20. For example, gateway node 20 can assign each sensor node 20 a frequency band based on a type of data received from the sensor node, a noise level associated with the sensor node, and/or other parameter. In some implementations, gateway node 110 can broadcast a time and/or modulation associated with each frequency band, such that sensor nodes 20 can determine when to transmit data to gateway node 110. For example, gateway node 110 may broadcast to sensor nodes 20 that frequency band F1 will be associated with a DSS modulation scheme for a time period t1, frequency band F2 will be associated with a FSK modulation scheme for time period t2, frequency band F3 will be associated with a OFDM modulation scheme for time period t3, frequency band F4 will be associated with a DSS modulation scheme for a time period t4, frequency band F5 will be associated with a FSK modulation scheme for time period t5, and frequency band F6 will be associated with a OFDM modulation scheme for time period t6. Each sensor node 20 can then determine when to transmit data to gateway node 110. Alternatively, gateway node 110 can assign time, frequency, and/or modulation schemes to sensor nodes 20, such that gateway node 110 schedules when sensor nodes 20 transmit data. In such applications, sensor nodes 20 can also implement wideband transceivers, such as those described herein, such that sensor nodes 20 also have versatile communication standards and/or modulation schemes, and can transmit data on various frequency bands using various modulation schemes. In various implementations, gateway node 110 can transmit data to a network element and/or network once the aircraft 210 is on the ground. It is noted that, in applications other than avionics applications, gateway node 110 can include a single RF transceiver that can be configured with the time, frequency, and modulation scheduling capabilities described with reference to the avionics applications.

Gateway node 110 can also include an inertial measurement unit (IMU), such as a digital barometer, for determining a height of aircraft 210. Gateway node 110 can further include a global positioning system. In typical use cases, gateway node 110 can aggregate data using the radio altimeter frequency band. In action-on-alert cases, when a sensor node 20 notifies gateway node 110 that a sensor has failed, gateway node 110 can use a GPS position provided by the GPS and three-axis velocity and acceleration (for example, provided by the digital barometer) to analyze the sensor failure. By implementing the GPS, gateway node 110 essentially creates a black box.

In various implementations, components of the FIGURES can be implemented on a board of an associated electronic device. The board can be a general circuit board that can hold various components of an internal electronic system of the electronic device and, further, provide connectors for other peripherals. The board can provide the electrical connections by which the other components of the system can communicate electrically. Any suitable processors (inclusive of digital signal processors, microprocessors, supporting chipsets, etc.), memory elements, etc. can be suitably coupled to the board based on particular configuration needs, processing demands, computer designs, other considerations, or a combination thereof. Other components, such as external storage, sensors, controllers for audio/video display, and peripheral devices may be attached to the board as plug-in cards, via cables, or integrated into the board itself. In various implementations, components of the FIGURES can be implemented as stand-alone modules (for example, a device with associated components and circuitry configured to perform a specific application or function) or implemented as plug-in modules into application specific hardware of electronic devices. Note that particular embodiments of the present disclosure may be readily included in a system-on-chip (SOC) package, either in part, or in whole. An SOC represents an integrated circuit that integrates components of a computer or other electronic system into a single chip. It may contain digital, analog, mixed-signal, and often radio frequency functions: all of which may be provided on a single chip substrate. Other embodiments may include a multi-chip-module (MCM), with a plurality of separate ICs located within a single electronic package and configured to interact closely with each other through the electronic package. In various other embodiments, the various functions described herein may be implemented in one or more semiconductor cores (such as silicon cores) in application specific integrated circuits (ASICs), field programmable gate arrays (FPGAs), other semiconductor chips, or combinations thereof.

The various functions outlined herein may be implemented by logic encoded in one or more non-transitory and/or tangible media (for example, embedded logic provided in an application specific integrated circuit (ASIC), as digital signal processor (DSP) instructions, software (potentially inclusive of object code and source code) to be executed by a processor, or other similar machine, etc.). In some of these instances, a memory element can store data used for the operations described herein. This includes the memory element being able to store logic (for example, software, code, processor instructions) that is executed by a processor to carry out the activities described herein. The processor can execute any type of instructions associated with the data to achieve the operations detailed herein. In various implementations, the processor can transform an element or an article (such as data) from one state or thing to another state or thing. In another example, the activities outlined herein may be implemented with fixed logic or programmable logic (such as software/computer instructions executed by the processor) and the elements identified herein can be some type of a programmable processor (such as a DSP), programmable digital logic (e.g., a FPGA, an erasable programmable read only memory (EPROM), an electrically erasable programmable ROM (EEPROM)), or an ASIC that includes digital logic, software, code, electronic instructions, or any suitable combination thereof.

Note that the activities discussed above with reference to the FIGURES are applicable to any integrated circuits that involve signal processing, particularly those that can execute specialized software programs or algorithms, some of which may be associated with processing digitized real-time data. Certain embodiments can relate to multi-DSP signal processing, floating point processing, signal/control processing, fixed-function processing, microcontroller applications, etc. In certain contexts, the features discussed herein can be applicable to medical systems, scientific instrumentation, wireless and wired communications, radar, industrial process control, audio and video equipment, current sensing, instrumentation (which can be highly precise), and other digital-processing-based systems. Moreover, certain embodiments discussed above can be provisioned in digital signal processing technologies for medical imaging, patient monitoring, medical instrumentation, and home healthcare. This could include pulmonary monitors, accelerometers, heart rate monitors, pacemakers, etc. Other applications can involve automotive technologies for safety systems (e.g., stability control systems, driver assistance systems, braking systems, infotainment and interior applications of any kind). Furthermore, powertrain systems (for example, in hybrid and electric vehicles) can use high-precision data conversion products in battery monitoring, control systems, reporting controls, maintenance activities, etc. In yet other example scenarios, the teachings of the present disclosure can be applicable in the industrial markets that include process control systems that help drive productivity, energy efficiency, and reliability. In consumer applications, the teachings of the signal processing circuits discussed above can be used for image processing, auto focus, and image stabilization (e.g., for digital still cameras, camcorders, etc.). Other consumer applications can include audio and video processors for home theater systems, DVD recorders, and high-definition televisions. Yet other consumer applications can involve advanced touch screen controllers (e.g., for any type of portable media device). Hence, such technologies could readily be a part of smartphones, tablets, security systems, PCs, gaming technologies, virtual reality, simulation training, etc.

The specifications, dimensions, and relationships outlined herein have only been offered for purposes of example and teaching only. Each of these may be varied considerably without departing from the spirit of the present disclosure, or the scope of the appended claims. The specifications apply only to non-limiting examples and, accordingly, they should be construed as such. In the foregoing description, example embodiments have been described with reference to particular processor and/or component arrangements. Various modifications and changes may be made to such embodiments without departing from the scope of the appended claims. The description and drawings are, accordingly, to be regarded in an illustrative rather than a restrictive sense.

Note that with the numerous examples provided herein, interaction may be described in terms of two, three, four, or more processing components. However, this has been done for purposes of clarity and example only. It should be appreciated that the system can be consolidated in any suitable manner. Along similar design alternatives, any of the illustrated components, modules, circuits, and elements of the FIGURES may be combined in various possible configurations, all of which are clearly within the broad scope of this Specification. In certain cases, it may be easier to describe one or more of the functionalities of a given set of flows by only referencing a limited number of processing components. It should be appreciated that the processing components of the FIGURES and its teachings are readily scalable and can accommodate a large number of components, as well as more complicated/sophisticated arrangements and configurations. Accordingly, the examples provided should not limit the scope or inhibit the broad teachings of the processing system and/or components as potentially applied to a myriad of other architectures.

Further, note that references to various features (e.g., elements, structures, modules, components, steps, operations, characteristics, etc.) included in “one embodiment”, “example embodiment”, “an embodiment”, “another embodiment”, “some embodiments”, “various embodiments”, “other embodiments”, “alternative embodiment”, and the like are intended to mean that any such features are included in one or more embodiments of the present disclosure, but may or may not necessarily be combined in the same embodiments. It is further noted that “coupled to” and “coupled with” are used interchangeably herein, and that references to a feature “coupled to” or “coupled with” another feature include any communicative coupling means, electrical coupling means, mechanical coupling means, other coupling means, or a combination thereof that facilitates the feature functionalities and operations, such as the security check mechanisms, described herein.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “steps for” are specifically used in the particular claims; and (b) does not intend, by any statement in the specification, to limit this disclosure in any way that is not otherwise reflected in the appended claims.

1. A system for wirelessly transmitting power to radio frequency (RF) energy harvesting sensor nodes of a wireless network system, the system comprising:
a pyramid-structured antenna array for wirelessly powering RF energy harvesting sensor nodes within a defined coverage area of the wireless network system, wherein the pyramid-structured antenna array is configured to generate a radiation pattern from a spread-spectrum signal that minimizes destructive interference between adjacent antennas of the antenna array, and further wherein each antenna of the antenna array is configured to wirelessly transmit power to a respective sector of the defined coverage area.

2. The system of claim 1, wherein the spread-spectrum signal is an orthogonal spread-spectrum signal.

3. The system of claim 1, wherein each antenna of the antenna array generates a respective radiation pattern from RF signals modulated with different orthogonal spread-spectrum sequences.

4. The system of claim 1, wherein the antenna array includes four antennas, and the sector of each antenna has an angle of coverage of about 90 degrees.

5. The system of claim 1, further configured to wirelessly transmit power to the RF energy harvesting sensor nodes without using an uplink communication link from the RF energy harvesting sensor nodes to gather three-dimensional location information associated with the RF energy harvesting sensor nodes.

6. The system of claim 1, wherein the pyramid-structured antenna array delivers a uniform radiation pattern, such that a same power is transmitted to a sensor node irrespective of a location of the sensor node within the defined coverage area.

7. The system of claim 1, wherein the pyramid-structured antenna array includes:
a pyramid-shaped ground board formed from pyramid-shaped ground planes; and
a patch antenna mounted to each pyramid-shaped ground plane.

8. The system of claim 1, further comprising a phase modulator for each antenna of the antenna array, wherein each phase modulator modulates an RF signal fed to a respective antenna using a different orthogonal spread-spectrum sequence.

9. The system of claim 1, wherein the antenna array is further configured to vary the radiation pattern to selectively power on/off or selectively charge at least one RF energy harvesting sensor node within the defined coverage area.

10. The system of claim 1, wherein the antenna array is further configured to selectively switch each antenna in/out of the antenna array to vary the radiation pattern to achieve a defined quality of service.

11. A method for wirelessly transmitting power, the method comprising:
modulating at least two radio frequency (RF) signal components of an RF signal using orthogonal spread-spectrum sequences; and
feeding the at least two, modulated RF signal components to an antenna array for generating a radiation pattern.

12. The method of claim 11, further comprising amplifying the at least two modulated, RF signal components before feeding to the antenna array.

13. The method of claim 11, further comprising:
generating the radio frequency signal; and
dividing the radio frequency signal into the RF signal components.

14. The method of claim 11, wherein the orthogonal spread-spectrum sequences are selected to minimize destructive interference in the radiation pattern between adjacent antennas of the antenna array.

15. The method of claim 11, further comprising varying the radiation pattern to selectively power on/off or selectively charge at least one RF energy harvesting sensor node within a defined coverage area of a wireless network system

16. The method of claim 11, further comprising selectively switching each antenna in/out of the antenna array to vary the radiation pattern to achieve a defined quality of service.

17. A radio frequency (RF) charging system comprising:
an antenna array configured to generate a radiation pattern; and
a processing stage for feeding each antenna of the antenna array a different spread-spectrum signal, wherein the processing stage includes:
a phase modulator configured to modulate an RF signal component using a spread-spectrum sequence, and
an amplifier configured to amplify the modulated RF signal component.

18. The RF charging system of claim 17, wherein the spread-spectrum signal is an orthogonal spread-spectrum signal.

19. The RF charging system of claim 17, further comprising:
a RF transceiver for generating an RF input signal; and
a power splitter for dividing the RF input signal into respective RF signal components for each antenna of the antenna array.

20. The RF charging system of claim 17, wherein the antenna array is a pyramid-structured antenna array that includes:
a pyramid-shaped ground board formed from pyramid-shaped ground planes; and
a patch antenna mounted to each pyramid-shaped ground plane.
